(19) United States
(12) Patent Application Publication
(10) Pub. No.: US 2013/0163944 A1
(43) Pub. Date: Jun. 27, 2013

(54) DROP-IN GROUNDING ELEMENT FOR CABLE MANAGEMENT SYSTEM

(71) Applicant: ADC TELECOMMUNICATIONS, INC., Berwyn, PA (US)

(72) Inventor: DENNIS KRAMPOTICH, Shakopee, MN (US)

(73) Assignee: ADC TELECOMMUNICATIONS, INC., Berwyn, PA (US)

(21) Appl. No.: 13/724,614

(22) Filed: Dec. 21, 2012

Related U.S. Application Data
(60) Provisional application No. 61/579,311, filed on Dec. 22, 2011.

(51) Int. Cl. G02B 6/46

(52) U.S. Cl. CPC G02B 6/46
USPC 385/135

(57) ABSTRACT

A cable management system includes a chassis and a drawer slidably mounted in the chassis. A tray may be removably received in the drawer. Different types of tray may be used, but each panel generally supports at least one of a cable, a telecom component, and a cable storage device. A spring is located between the tray and the drawer for grounding the tray to the chassis. The spring may be connected to at least one of the drawer and the tray, typically by a fastener.

### CROSS-REFERENCE TO RELATED APPLICATIONS

This application claims priority to U.S. Provisional Application No. 61/579,311, filed Dec. 22, 2011, and titled “Drop-in Grounding Element for Cable Management System,” the disclosure of which is hereby incorporated herein by reference.

### BACKGROUND

Cable management systems are used in fiber-optic and other cable systems for storage and management of cables. Lengths of cable loops, connection terminals, cable testing and other equipment, and additional components are located on removable trays that are stored in drawers of the cable management systems. These systems are located at various points within optical fiber systems, as required or desired, and may be accessed by technicians as needed. The systems are extremely versatile, since any combination of cables, equipment, and other components may be located on a particular tray.

### SUMMARY

In one aspect, the technology relates to a cable management system including: a chassis; a drawer slidably mounted in the chassis; a tray removably received in the drawer, the tray adapted to support at least one of a cable, a telecommunications component, and a cable storage device; and a spring for grounding the tray to the chassis, wherein the spring is connected to at least one of the drawer and the tray.

### BRIEF DESCRIPTION OF THE DRAWINGS

There are shown in the drawings, embodiments which are presently preferred, it being understood, however, that the technology is not limited to the precise arrangements and instrumentalities shown.

FIGS. 1-3 are perspective, top, and side sectional views, respectively, of a cable management system with a sliding drawer in an open position.

FIG. 4 is a perspective view of a contact element and a cable management system being inserted into the sliding drawer of FIG. 1.

FIGS. 5-7 are perspective, top, and side sectional views, respectively, of the cable management system of FIG. 1 with the cable management tray of FIG. 4 inserted.

FIG. 8 is a perspective view of a contact element.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

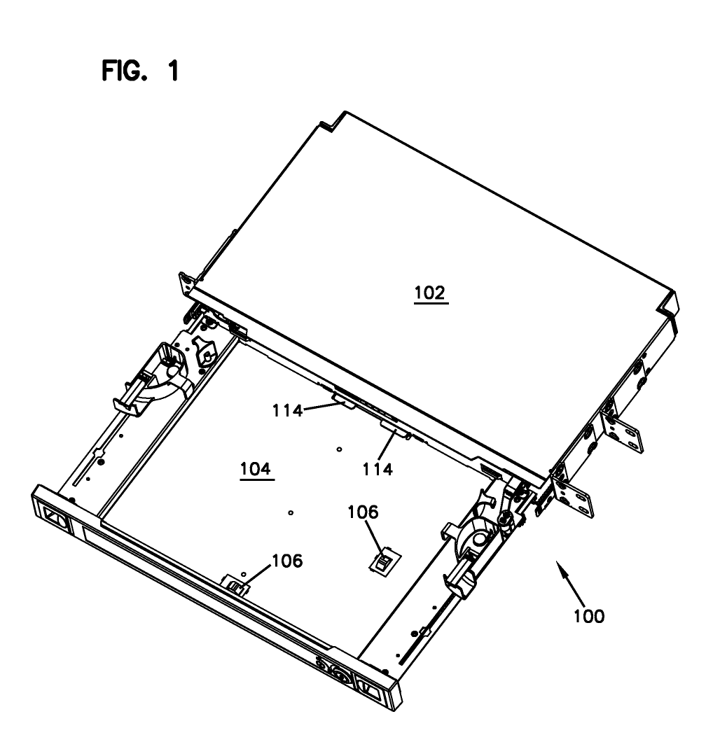

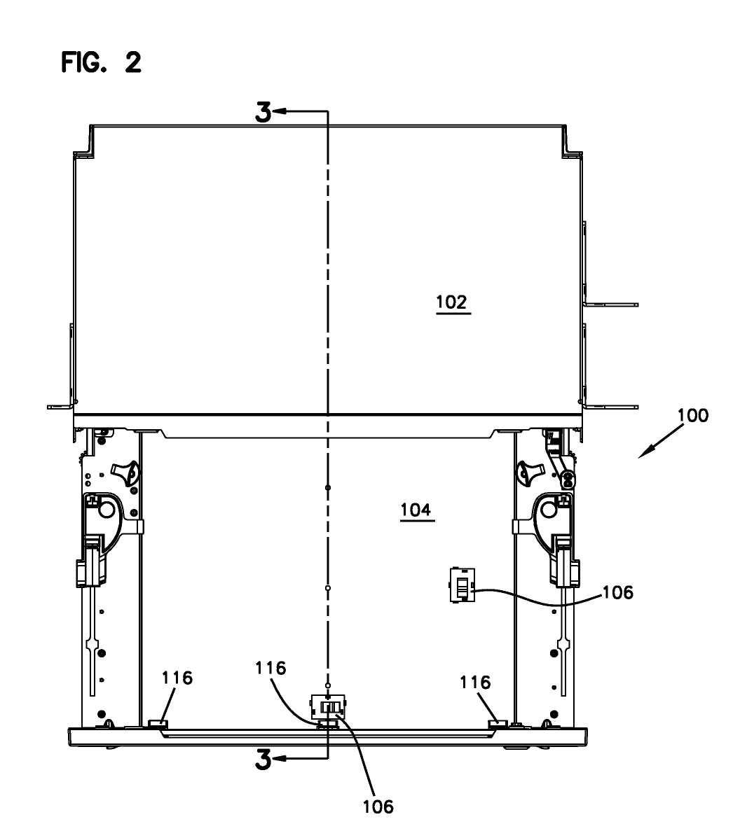

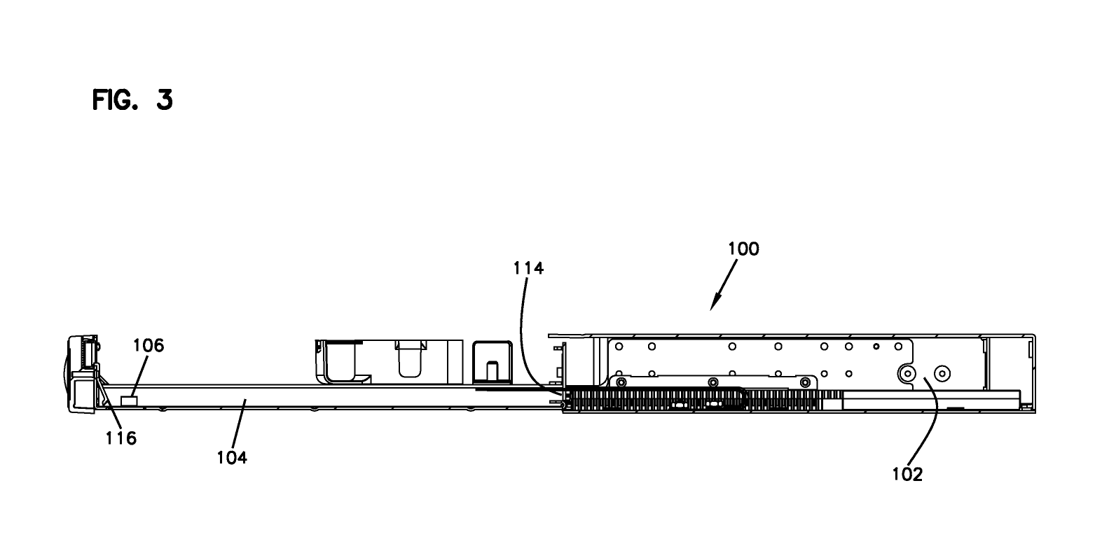

FIGS. 1-3 depict a cable management system 100. The system 100 includes a housing or chassis 102 and a drawer 104 slidably mounted thereto. The drawer 104 may be slidably moved into and out of the chassis 102 on a pair of drawer slides. Cable management systems, as well as components contained therein, are described in U.S. Pat. Nos. 6,968,111; 7,079,744; 7,397,996; and 7,764,859; the disclosures of which are hereby incorporated by reference herein in their entireties. In general, lengths of cable loops, connection terminals, cable testing equipment, telecommunications components, optical components, computer components, and other components or equipment are stored in the drawers of the cable management systems.

As with other electrical equipment, it is advantageous to ground the components located on a tray or panel of the cable management system. In certain cases, the drawers may not be manufactured of a conductive material (i.e., they may be manufactured of robust plastic or some other material having similar non-conductive properties). In these systems, the tray or panel is isolated from the ground, and an electrostatic hazard may exist. In other embodiments of the cable management trays, both the trays and the drawers may be fabricated from conductive material, such as metal. However, contact between the tray and its associated drawer is not assured, since plastic or other non-conductive elements may be used to support the tray and to prevent wobbling of the tray in the drawer. These non-conductive elements also isolate the tray and components thereon from the ground. Paint or other coatings on metal parts may affect the conductive properties as well.

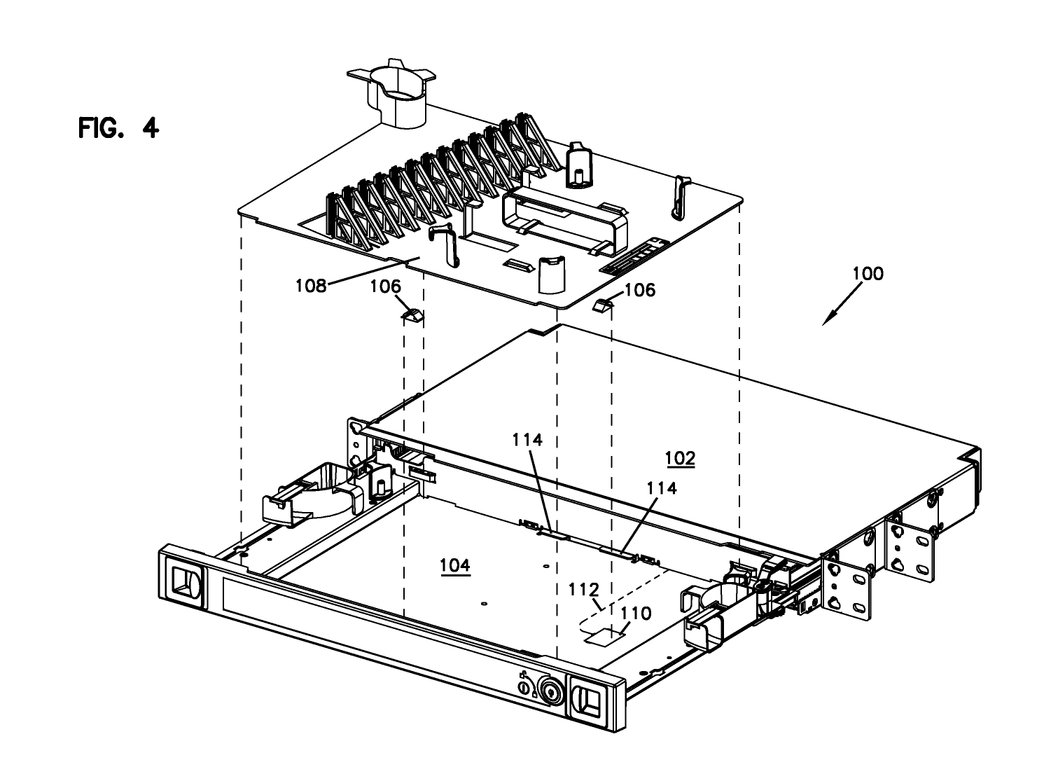

To obviate the shortcomings, the cable management system 100 depicted in FIG. 4 includes a spring or other contact element 106 that ensures contact between a tray or panel 108 and the drawer 104. One or more contacts 106 may be used, as required or desired for a particular application. FIG. 4 depicts a tray 108 being received in the drawer 104 of a cable management system 100. In this embodiment, two contacts 106 are first installed in the drawer 104. The contacts 106 depicted herein could be installed in any of the cable management systems described in the patents listed above (or other similar systems), which makes them particularly useful in retrofit applications. To install the contact 106, the drawer 104 may first need to be prepared. In the case of conductive drawers, any paints, coatings or other material that may interfere with conduction should first be removed via either sanding and/or chemical processes to form a contact surface 110. In newly manufactured drawers, the contact surface may be covered with a removable tape or other material and removed after painting or other treating to expose the clean contact surface 110. Grounding contact between the drawer 104 and the chassis 102 may be direct (i.e., due to the physical contact between those components). In other embodiments where the drawer is not in grounding contact with the chassis (due to the use of plastic contacting components, for example), a flexible conductive element such as a wire may be used to connect the contact surface 110 to the chassis 102 to ensure grounding contact.

In embodiments of the cable management system that include non-conductive drawers, the contact surface 110 may be a conductive metal or other plate secured to the drawer 104. Connected to this contact surface 110 is a conductive element 112, such as a wire, that is routed along an upper or lower surface of the drawer 104 and connected to a conductive element on the drawer 104 (a side wall, for example), or connected directly to the chassis 102, as desired. Alternatively, the drawer 104 is made of conductive material that is grounded to chassis 102 or other grounding location.

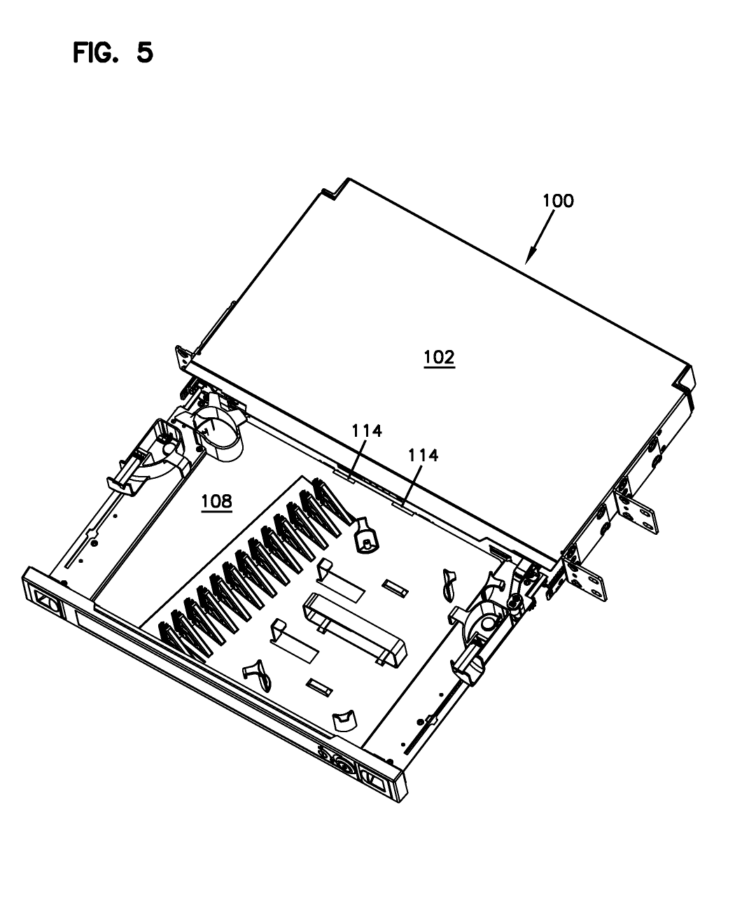

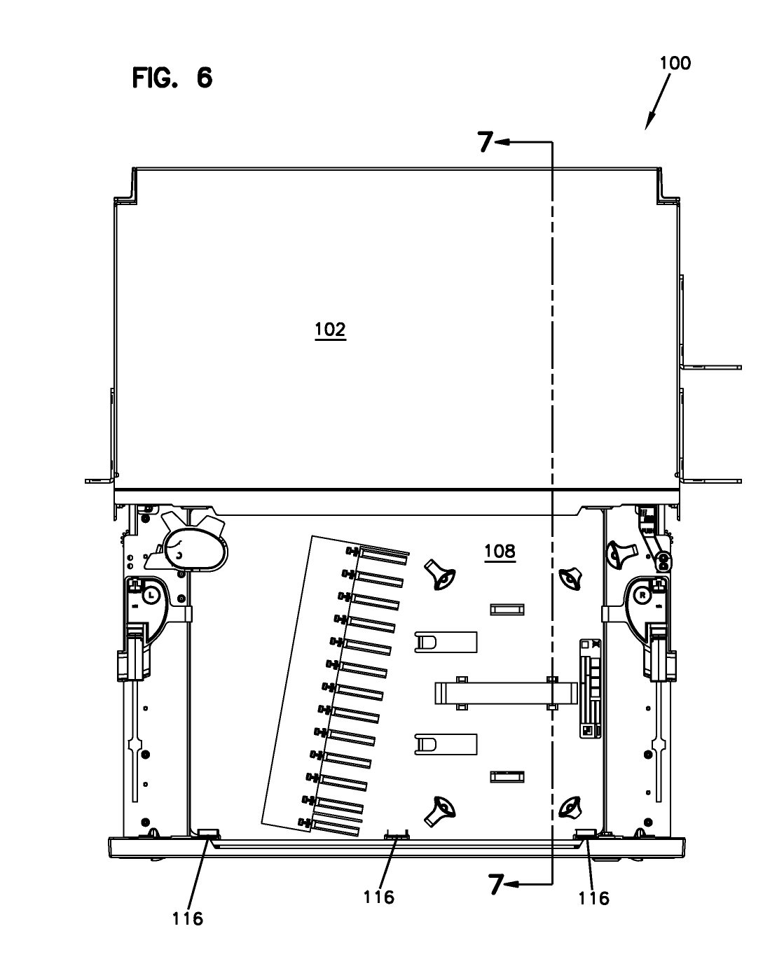

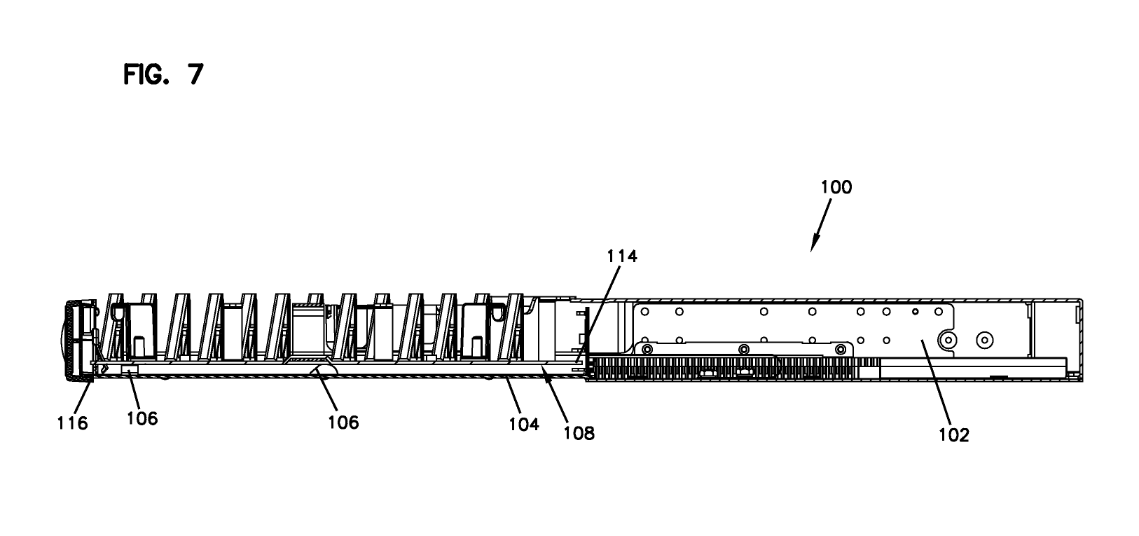

FIGS. 5-7 depict the cable management system 100 with the tray 108 received in the drawer 104. The weight of the tray 108 and the components located thereon deflects the contacts 106, ensuring grounding contact between the tray 108 and the drawer 104. Additionally, components located in the drawer 104 help hold the tray 108 in place, against the contacts 106. In the depicted embodiment, these components include a plurality of lips 114 located proximate one end of the drawer 104 and a plurality of tabs 116 located proximate another end of the drawer 106. One end of the tray 108 is inserted under the lip 114 and the opposite end is pressed down until the tab 116 engages the tray 108. To remove the tray 108, the tab 116 is deflected until the tray 108 is disengaged, after which the tray 108 may be removed. Additionally, or alternatively, the tray 108 may be secured within the drawer 104 using one or more screws, bolt, or other fasteners. Any number of lips, tabs, and/or screws may be used, as required or desired for a particular application.

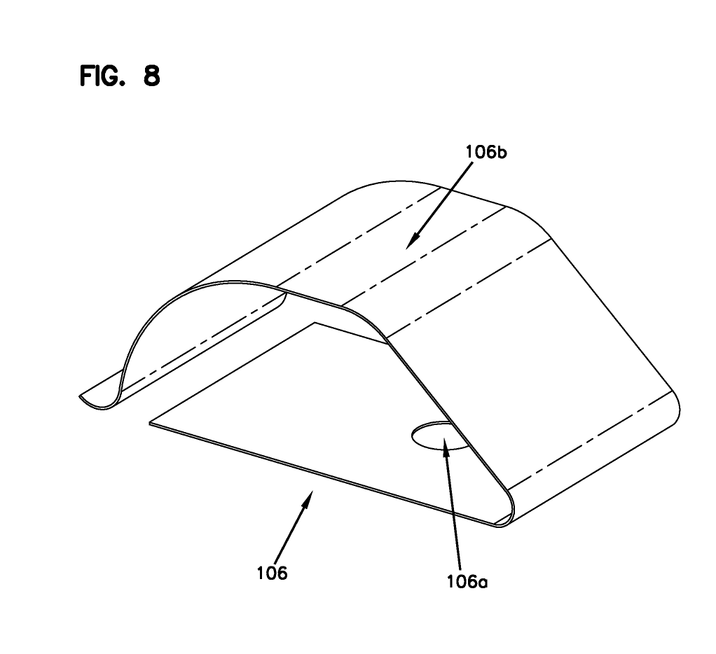

FIG. 8 is a perspective view of a contact element 106. The contact 106 is formed as a D-spring and includes an opening 106a for connecting the contact 106 to the drawer 104 or contact surface 110 described above. The connector used may be a screw, bolt, press-fit connection or other means. In certain embodiments, conductive adhesives may also be used. The contact 106 also includes a top surface 106b that is a predetermined height above the base of the contact 106. This height should be higher than the maximum height of any support elements located in the drawer 104 for supporting the tray 108 (as described above). Other embodiments of the contact element are contemplated. For example, leaf springs having an upper surface higher than the lower surface may also be used. Coil springs may also be used. In general, any deflectable conductive element may be used as the contact element. The contact element may be a discrete element, as depicted, or may be formed as an integral part of the tray or drawer. Additionally, the contact element may be fixed to a bottom of the tray and may be configured to contact the drawer.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A cable management system comprising:
a chassis;
a drawer slidably mounted in the chassis;
a tray removably received in the drawer, the tray adapted to support at least one of a cable, a telecom component, and a cable storage device; and
a spring for grounding the tray to the chassis, wherein the spring is connected to at least one of the drawer and the tray.

2. The cable management system of claim 1, wherein the spring comprises a deflectable element, wherein the element is adapted to be deflected by the tray when the tray is received in the drawer.

3. The cable management system of claim 1, wherein the spring comprises a D-shaped spring.

4. The cable management system of claim 1, wherein the drawer is fabricated from a non-electrically conductive material and the tray is fabricated from an electrically conductive material.

5. The cable management system of claim 4, further comprising a conductive element connecting the spring to the chassis.

6. The cable management system of claim 5, wherein the conductive element comprises at least one of a wire and a plate.

7. The cable management system of claim 1, wherein each of the tray and the drawer are fabricated from a conductive material.

8. The cable management system of claim 1, wherein the spring is discrete from at least one of the drawer and the tray.

9. The cable management system of claim 1, wherein the spring is integral with at least one of the drawer and the tray.

10. The cable management system of claim 1, further comprising a tab for securing the tray in the drawer.
